(19) United States
(12) Patent Application Publication
(10) Pub. No.: US 2002/0141436 A1
(43) Pub. Date: Oct. 3, 2002

(54) Downlink dedicated physical channel (DPCH) with control channel interleaved for fast control of a separate high speed downlink common channel

(75) Inventor: Antti Toskala, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Mobile Phone Ltd.

(21) Appl. No.: 09/824,538

(22) Filed: Apr. 2, 2001

(51) Int. Cl. H04J 3/02; H04B 7/212

(52) U.S. Cl. 370/442; 370/537

(57) ABSTRACT

A dedicated physical channel (DPCH) structure is modified to make room dynamically or in a fixed way, e.g., every fifth slot of a frame for the signaling needed for high speed data packet access (HSDPA) features provided by a new HSDPA common channel, using the dedicated physical data channel (DPDCH) field position (e.g., in the fifth, tenth and fifteenth slots) for HSDPA signaling and leaving the remaining fields of these slots for current signaling needs such as for the transmission power control (TPC) and pilot signaling.

### BACKGROUND OF INVENTION

1. Technical Field

The present invention relates to wireless telecommunications and, more particularly, to signaling for high speed downlink packet access in a radio access network.

2. Discussion of Related Art

High speed downlink packet access (HSDPA) is to support high peak rates using techniques like adaptive modulation and coding, hybrid automatic retransmission request (HARQ) and other advanced features. A new physical layer to accommodate HSDPA and features such as the above-mentioned adaptive coding & modulation and HARQ results in new signaling needs. In HSDPA there will be a common channel, called the high speed downlink shared channel (HS—DSCH) that will require associated signaling for each user equipment (UE). There is a need to provide some signaling information in advance, as is practiced with the current DCH plus DSCH case (DCH+DSCH), in which the dedicated channel (DCH) is used to provide such advance information for the downlink shared channel (DSCH). The DSCH is a transport channel intended to carry dedicated user data and/or control information; it can be shared by several users. The dedicated channel (DCH) carries all the information intended for the given user coming from layers above the physical layer, including data for the actual service as well as higher layer control information.

### DISCLOSURE OF INVENTION

An object of the present invention is to provide a control channel for providing signaling related to high speed downlink packet access.

According to a first aspect of the present invention, a method for providing a dedicated channel for transport on a downlink dedicated physical channel (DPCH) comprising a downlink dedicated physical data channel (DPDCH) and a downlink dedicated physical control channel (DPCCH) comprises the steps of receiving digital user data bits for transport on the DPDCH, receiving first digital control bits related to or for controlling the DPDCH for transport on the DPCCH, receiving second digital control bits related to or for controlling a high speed downlink packet access (HSDPA) common channel (HS—DSCH), and multiplexing the digital user data bits, the first digital control bits and the second digital control bits for transport on the downlink DPCH.

According to a second aspect of the present invention, an apparatus for providing a dedicated channel (DCH) for transport on a downlink dedicated physical channel (DPCH) comprising a downlink dedicated physical data channel (DPDCH) and a downlink dedicated physical control channel (DPCCH), comprises the steps of means for providing digital user data bits for transport on the DPDCH, means for providing first digital control bits related to or for controlling the DPDCH for transport on the DPCCH, means for providing second digital control bits related to or for controlling a high speed downlink packet access (HSDPA) common channel (HS-DSCH), and means for multiplexing the digital user data bits, the first digital control bits and the second digital control bits for transport as a modified downlink DPCH.

In accordance with both the first and second aspects of the present invention, the second digital control bits can be multiplexed into one or more slots of the frame of the downlink DPCH. These slots can also be occupied in part by selected first digital control bits. This can be with or without the digital user data bits.

In still further accord with the first and second aspects of the present invention, the one or more slots of a frame of the downlink DPCH used for the second digital control bits may be fixed in a same position within repetitive frames. On the other hand, the number of slots used for the second digital control bits can be variable within the repetitive frames. In other words, the slots used for the second digital control bits can be fixed or variable in position, number, or both.

The signaling needs for this new HSDPA vary more in the time domain than with the current physical layer signaling needs, such as power control or TFCI (transport format combination indicator). Dimensioning the physical layer control signaling capability (DPCCH) constantly for the maximum need reduces the room available for the higher layer data on the DPDCH or requires the use of a higher spreading factor which consumes the available orthogonal code resource. It is essential however to have the signaling in as short a time as possible in order to have the processing requirements on the receiver and the total delay involved for the signaling within reasonable bounds. Previously, in WCDMA, the DPCCH part has been fixed in each slot. Some features have used puncturing of some of the power control bits.

The present invention applies a time variant DPCCH structure which has the capability to distribute the HSDPA signaling load evenly in the time domain over the duration of the frame. This gives more room for the signaling but allows the spreading factor to remain small. TFCI performance degradation remains small as well. In those DPCCH slots where HS-DSCH control information is transmitted, only pilot bits and transmission power control (TPC) bits need remain.

These and other objects, features and advantages of the present invention will become more apparent in light of the following detailed description of a best mode embodiment thereof, as illustrated in the accompanying drawing.

### BRIEF DESCRIPTION OF THE DRAWING

FIG. 1 shows the dedicated channels (DPDCH and DPCCH) being multiplexed with the control channel for controlling a high speed downlink packet access common channel, according to the present invention.

FIG. 2 shows TFCI replacement, according to the present invention.

FIG. 3 shows TFCI and DPDCH field replacement approach, according to the present invention.

### BEST MODE FOR CARRYING OUT THE INVENTION

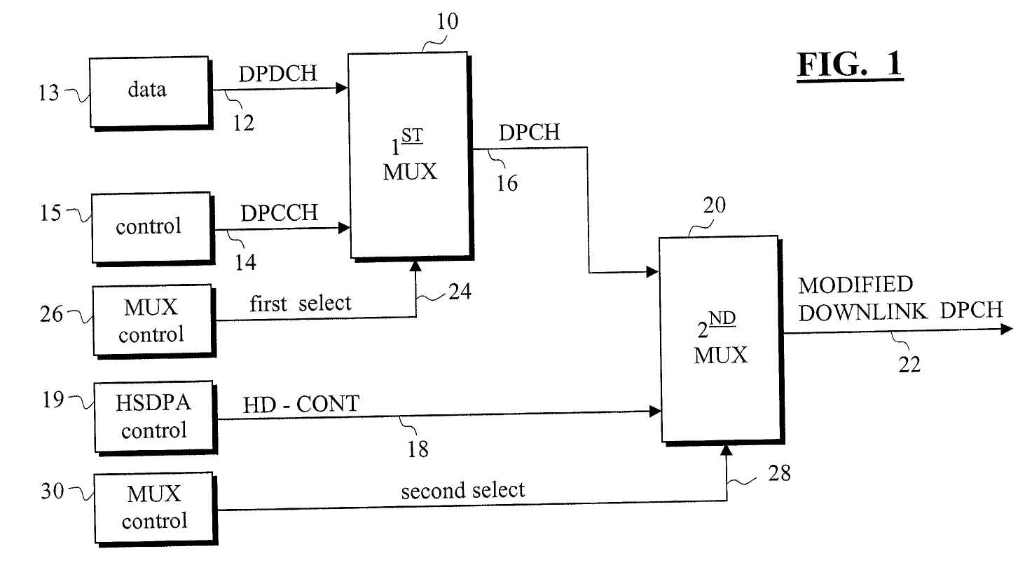

FIG. 1 shows a multiplexer, combiner or interleaver 10 receiving data in the form of a dedicated physical data channel (DPDCH) on a line 12 from a data signal source 13 and also receiving control information in the form of a dedicated physical control channel (DPCCH) on a line 14 from a first control signal source 15 for combination according to known techniques into a dedicated physical channel (DPCH) on a line 16 for transporting a dedicated channel (DCH). According to the present invention, the dedicated channel (DCH) is modified on the downlink by introducing control information related to or for controlling a high speed downlink packet access (HSDPA) common channel (not shown). Such information is shown on a line 18 from a second control signal source 19 in FIG. 1 being received by a second multiplexer, combiner or interleaver 20. The multiplexer 20 also receives the dedicated channel on the line 16 for multiplexing the signals on the lines 16 and 18 into a single modified downlink dedicated physical channel on a line 22.

This modified downlink dedicated physical channel (DPCH) can have various structures, according to the present invention.

It should be realized that the first multiplexer 10 is responsive to a first selection signal on a line 24 for controlling the insertion of data or control into the various time slots available in a preexisting structure selected for the DPCH signal on the line 16. This control signal on the line 24 is provided by a first multiplexer control device 26. Similarly, the modified downlink DPCH signal on the line 22 has a preselected structure with a number of time slots existing in a given period of time in a repetitive frame. Such might be a preselected fifteen time slot structure in a ten millisecond frame, for example. The second multiplexer 20 is likewise under the control of a second selection signal on a line 28 from a second multiplexer control device 30. The second selection signal on the line 28 determines when a slot will be occupied by HSDPA signaling from the line 18 or DPCH information from the line 16 according to various structures such as described below. It should also be realized that the two stage multiplexing structures of FIG. 1 can be carried out as a single stage of multiplexing with a single multiplexer receiving the three signals on the lines 12, 14, 18 for providing the modified downlink DPCH signal on the line 22 under the control of a single selection signal. Therefore, it will be realized that a single multiplexer with a single control signal is equivalent to the two stages of multiplexing shown in FIG. 1. Likewise, the data source 13 as well as the channel control signaling 15, 19 and the multiplexing control signaling 26, 30 blocks of FIG. 1 can be combined with other blocks. It will also be realized that such functions are implementable in hardware or software and that the boundary between hardware and software functionalities is readily transferable.

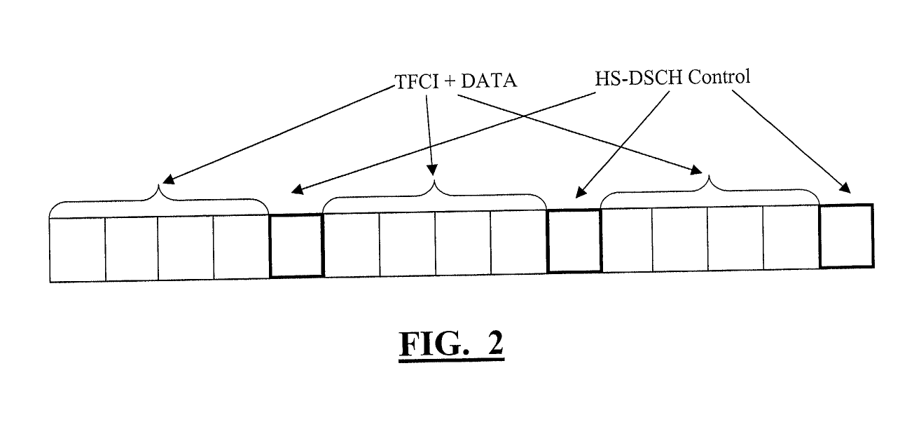

FIG. 2 shows an example, according to the present invention, of fixed mapping onto fifteen slot frames of a dedicated physical channel (DPCH) of the above-mentioned signaling information required in advance for the HSDPA common channel. In this example, every fifth slot is made available for the HSDPA signaling (HS-DSCH Control), i.e., slots 4 (the fifth slot), 9 (the tenth slot), and 14 (the fifteenth slot). But some other slot or combination of slots could be dedicated for this purpose. For instance, slots 2 and 4 could be so dedicated along with slots 7 and 9 and slots 12 and 14. Again, the example of FIG. 2 is a mapping with a five-slot structure repeated three times. One of the five slots has HS-DSCH signaling in place of the TFCI field and the user data field, while the other four have the TFCI field plus data. The HS-DSCH signaling might be for example a pointer for existence of another control channel, a pointer to a specific control channel from a group of control channels and/or an indication of the power level of the HS-DSCH versus CPICH power level for QAM-demodulation. With the 15 slot configuration, the HS-DSCH could have three slots for signaling, as shown, and 12 slots would map the remaining TFCI bits for purposes of the dedicated channel, such as higher layer signaling for a 3.4 kbits/s (for example) control channel.

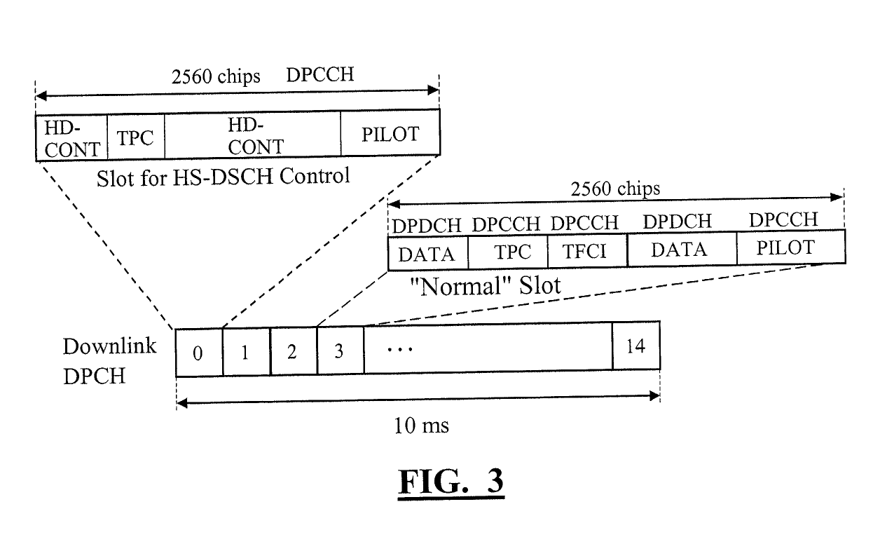

As known in the art, the dedicated transport channel is transported on two physical channels comprising a dedicated physical data channel (DPDCH) and a dedicated physical control channel (DPCCH) which are time multiplexed, combined or interleaved on to one physical channel as shown in FIG. 1. The control channel contains pilot, TFCI and TPC information while the data channel includes information intended for the given user. A “normal” slot is shown in FIG. 3 with DPDCH user data time multiplexed with DPCCH control bits of the pilot, TPC and TFCI type in respective fields or subslots. Other structures are, of course, possible within a normal slot (such as TFCI followed by DATA, TPC, DATA and PILOT fields or subslots).

Still referring to FIG. 3, according to another example of the present invention, one or more of the slots of a frame of a normal downlink DPCH is modified to create another repetitive physical control channel frame structure for the signaling needed to support the HSDPA features. The one or more slots are modified as shown, for instance, for slot 0 of FIG. 3 with user data and TFCI fields or subslots used for HD-CONT, leaving the rest of the code channel capability available for the current signaling needs, such as TPC and pilot signaling. The illustrated slot zero has the normal DPDCH user data fields replaced as well as the normal DPCCH TFCI field replaced with HS-DSCH control bits. The frame slots 1 and 2 could also contain HS-DSCH signaling according to this or another example. Beginning with slot 3, “normal” slots are then used as shown. Or, only slots 0, 5, and 10 might be used for HS-DSCH control. It is even possible to vary the position or to vary the number of slots used for HS-DSCH signaling between frames. Or, there might be conditions that activate/deactivate the HS-DSCH control and thereby change/resume the frame structure between frames to be with/without HS-DSCH control.

Therefore, it will be understood that besides that shown, various other approaches exist for populating slots with HS-DSCH signaling. In the most extreme case, as shown already, the DPCCH varies in such a way that there is no DPDCH on the slots when HS-DSCH control signaling is active, and the channel interleaver would span the user data over, e.g., only twelve of the slots illustrated in FIG. 3, but not at all in the HS-DSCH control slots. In such a case, the physical channel segmentation would use only the exemplary twelve slots to carry the DPDCH data. The less extreme approach (not shown) is that overall DPDCH duration is made constant and the TFCI and even the TPC field are made absent from the slot with HS-DSCH control information substituted therefor in order to make room. Various intermediate structures can be envisioned, according to the teachings hereof.

For the example of slot 0 in FIG. 3, with a spreading factor of 256 (sf=256) there will be 16 bits available for HS-DSCH control after a minimum configuration of the TPC symbol and two pilot bits (i.e., one pilot symbol). Over the frame shown in FIG. 2, DPDCH has 12 slots, leaving (depending on the TFCI and pilot length), approximately 140-150 bits/10 ms for data. This amount should be sufficient to carry 3.4 kbits/s control channel with CRCs and tail bits, etc.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Method of providing a dedicated channel (DCH) for transport on a downlink dedicated physical channel (DPCH) comprising a downlink dedicated physical data channel (DPDCH) and a downlink dedicated physical control channel (DPCCH), comprising the steps of:
receiving digital user data bits (12) for transport on the DPDCH,
receiving first digital control bits (14) related to the DPDCH for transport on the Dpcch,
receiving second digital control bits (18) related to a high speed downlink packet access (hsdpa) common channel (hs-dsch), and
multiplexing the digital user data bits, the first digital control bits and the second digital control bits for transport on the downlink dpch.

2. The method of claim 1, wherein the step of multiplexing comprises the step of multiplexing the second digital control bits into one or more slots of a frame of the downlink DPCH.

3. The method of claim 2, wherein the step of multiplexing comprises the step of multiplexing the second digital control bits into the one or more slots of a frame of the downlink DPCH along with selected first digital control bits.

4. The method of claim 2, wherein the one or more slots of a frame of the downlink DPCH used for the second digital control bits are fixed in a same position within repetitive frames.

5. The method of claim 2, wherein the one or more slots of a frame of the downlink DPCH used for the second digital control bits are variable in number within repetitive frames.

6. The method of claim 5, wherein the one or more slots of a frame of the downlink DPCH used for the second digital control bits are variable in position within the repetitive frames.

7. Apparatus of providing a dedicated channel (DCH) for transport on a downlink dedicated physical channel (DPCH) comprising a downlink dedicated physical data channel (DPDCH) and a downlink dedicated physical control channel (DPCCH), comprising the steps of:
means (13) for providing digital user data bits (12) for transport on the DPDCH,
means (15) for providing first digital control bits (14) related to the DPDCH for transport on the DPCCH,
means (19) for providing second digital control bits (18) related to a high speed downlink packet access (HSDPA) common channel (HS-DSCH), and
means (20) for multiplexing the digital user data bits (12), the first digital control bits (14) and the second digital control bits (18) for transport as a modified downlink DPCH.

8. The apparatus of claim 7, wherein the step of multiplexing comprises the step of multiplexing the second digital control bits (18) into one or more slots of a frame of the downlink DPCH.

9. The apparatus of claim 7, wherein the means for multiplexing multiplexes the second digital control bits (18) into a slot of a frame of the downlink DPCH along with selected first digital control bits (14).

10. The apparatus of claim 7, wherein the means for multiplexing multiplexes the digital user data bits (12) into a slot of a frame of the downlink DPCH along with the second digital control bits (18).

11. The apparatus of claim 8,wherein the one or more slots of a frame of the downlink DPCH used for the second digital control bits are variable in number within repetitive frames.

12. The apparatus of claim 11, wherein the one or more slots of a frame of the downlink DPCH used for the second digital control bits are variable in position within the repetitive frames.

13. The apparatus of claim 8, wherein the one or more slots of a frame of the downlink DPCH used for the second digital control bits are variable in position within repetitive frames.

14. The apparatus of claim 8, wherein the one or more slots of a frame of the downlink DPCH used for the second digital control bits are fixed in a same position within repetitive frames.
